(19) United States
(12) Patent Application Publication
(10) Pub. No.: US 2025/0376844 A1
(43) Pub. Date: Dec. 11, 2025

(54) MODULAR CONTAINMENT

(71) Applicant: Barrnon Ltd, Appleby-in-Westmorland, Cumbria (GB)

(72) Inventor: Andrew Fraser BARR, Appleby-in-Westmorland, Cumbria (GB)

(21) Appl. No.: 19/229,329

(22) Filed: Jun. 5, 2025

(30) Foreign Application Priority Data
Jun. 5, 2024 (GB) 2407995.6

(51) Int. Cl. E04C 2/38; E04C 2/08; E04C 2/10

(52) U.S. Cl. CPC E04C 2/384; E04C 2/08; E04C 2/10

(57) ABSTRACT

A structural panel for a modular containment system. The structural panel includes a flat rectangular panel having a front side, a rear side, and four edges; four side panels, each extending rearwardly from a different one of the four edges perpendicular to the rear side of the rectangular flat panel, each having a front edge affixed to the rectangular flat panel and a rear edge; and four rear tabs, each extending inwardly from a rear edge of a different one of the four side panels, and being parallel to the rear side of the flat panel. A modular containment system constructed of a plurality of structural panels is also provided. The modular containment system is formed by affixing the structural panels to one another.

### CROSS-REFERENCE TO RELATED APPLICATIONS

The present application is based upon and claims the right of priority to GB Patent Application No. 2407995.6, filed Jun. 5, 2024, the disclosure of which is hereby incorporated by reference herein in its entirety for all purposes.

### TECHNICAL FIELD

The present invention relates to a modular, reusable and reconfigurable containment system.

### BACKGROUND TO THE INVENTION

Temporary containment within a workspace has the purpose of creating a controllable operational environment within a larger space, thereby limiting or preventing egress or ingress of dust, gases or fragments of material and defining a dedicated work-zone which may entail specialised work practices and associated equipment. By temporarily enclosing a space a further purpose may be to control human access and limit or prevent the dissemination of possibly sensitive information.

A temporary containment structure, in order to be practical and cost-effective needs to be rapid to install, durable and adaptable to a range of use-cases.

Temporary containment structures exist in many forms and are put to a variety of uses including the containment of liquids, livestock, building works, also demolition, decommissioning and remediation works. In the case of nuclear decommissioning, additional requirements may be invoked including the need for easy and through cleaning and decontamination and installation of temporary containment structures in irradiated zones.

In one approach commercialised by BD Nuclear, panels made from fire-retardant Glass Reinforced Plastic can be assembled into temporary structures using industrial-scale lifting and manipulation equipment such as cranes and loaders. The panels exist in a variety of sizes and shapes and interlock. While this approach integrates the structure with the containment skin, the method of assembly requires large-scale equipment and this precludes installation of the temporary enclosure in environments that place a limit on the size of equipment deployable. The modular system furthermore requires elaborate tooling for manufacture and this limits the freedom to customise the system for new use-cases due to excessive cost and lead-time.

A containment system comprising a lightweight lattice-strut support structure and attachable panels, commercialised by Nu-Energy Technologies, can be assembled without recourse to large-scale industrial lifting and manipulation equipment. While this approach enables the creation of temporary enclosures in environments that may preclude the use of large-scale lifting and manipulation equipment, the containment skin and the structure are separate elements. This separation of constituent elements of the containment has the consequence that they must be mechanically united during assembly and mechanically disunited during disassembly. While this structure-and-panel approach provides means of temporary containment adaptable to a number of different tasks and environments, the method of installation and removal is onerous, slow and costly. The robustness of the installed containment structure may be deficient in cases where large-scale and high-power equipment is being used in the decommissioning process. Inadvertent contact by the equipment itself or the heavy impact of granulates and finer particles which may occur during, for example a sludge-removal phase of the decommissioning process, will tend to degrade and deform the containment structure and compromise its effectiveness and re-use. In the case of another common process in nuclear decommissioning, laser-cutting for size-reduction, a containment shield must be provided to prevent inadvertent projection of the laser beam beyond a defined operational envelope and it can be inferred that the lightweight panels are inappropriate for this use-case. The separate structure and panel configuration offers abundant attachment zones for dust and detritus, notably the exposed geometries of the support lattice and the elevated number of gaps between panels, making cleaning and decontamination onerous and largely impractical.

In industries adjacent to nuclear decommissioning, panels attached to a support structure are a commonly favoured solution for temporary containment and their example has been used to inform the design of the modular containment system commercialised by Nuvia. Glass-fibre panels are attached to a sectional rail system in a low-radiation environment. The partially assembled system is thereafter slid along a steel rail into a higher-radiation environment. The partial assembly and introduction into the higher-radiation environment process is repeated until the installation is completed. While this approach offers a means of installing a containment system in a high-radiation environment while obviating the need for human entry to that environment, decontamination of the system following use is costly, onerous and slow due to the complexity of the geometries of the support structure and the associated relatively large surface area, both of which offer purchase points for dust and foreign matter. The assembled system furthermore lacks robustness and is unsuited for use when large-scale and high-power equipment is being used for decommissioning, for example sludge-pumping, laser-cutting or the dismantling or large-scale and heavy equipment.

It is therefore the principal object of the present invention to provide a means of creating a temporary containment system that is mechanically robust and reusable, readily cleanable for the purposes of decontamination, rapid to install and adaptable to a wide range of use-cases and environments. While it is envisaged that the primary use for such a system is in nuclear decommissioning, the containment system may be advantageously applied in adjacent industries where robustness, re-use, reconfigurability, ease and speed of installation and ready cleanability are requirements.

A further object of the invention is the provision of means by which the manufacturing and installation of the system can be automated or semi-automated. Automation or semi-automation enables the cost of manufacture and installation to be reduced, and the time taken to achieve these outcomes to be minimised. Automation or semi-automation may furthermore enable the installation of the temporary containment system in an environment that is unsuited to human entry, notably the presence of Alpha particles. In this case, automated or semi-automated equipment takes the place of human operatives, removing them from risk to health or in some instances, death.

Other objects and advantages of the invention will be apparent from the following description.

### SUMMARY OF THE INVENTION

The present invention provides a structural panel for a modular containment system, the structural panel comprising:
a flat rectangular panel having a front side, a rear side, and four edges;
four side panels, each extending rearwardly from a different one of the four edges perpendicular to the rear side of the flat panel, each having a front edge affixed to the flat panel and a rear edge; and
four rear tabs, each extending inwardly from a rear edge of a different one of the four side panels, and being parallel to the rear side of the flat panel.

The structural panel may be considered to have a plurality of folded zones formed of the side panels and the rear tabs, wherein the folds may be parallel to the edges of the panel. The side panes may be generally rectangular and are positioned desirably perpendicular in respect to the flat rectangular panels to form side walls abutting where they meet at the corners of the flat rectangular panel, however other configurations are possible. The side panels may be four in number, however fewer side panels can in some cases be desirable. Rear tabs may be provided with an edge parallel to the edge of the side panel and will extend from the edge to a distance that defines the width of the rear tab. The rear tab may be perpendicular to the side panel and parallel to the flat rectangular panel to form a double folded structure taking the form of a C strut.

The structural panel may take the form of a square or of a rectangle and further forms of the panel can be envisaged including octagonal.

End portions of the rear tabs may be cut at an angle of 45° such that a pair of 45° angled edges meeting at an internal side of the structural panel abut.

Abutting edges of the side panels and rear tabs may be welded to form a robust structure. In the case of a structural panel comprising a total of C strut sections, the welding of the abutting side panels and rear tabs creates a three-dimensional structure capable of distributing mechanical forces and of resisting deformation when under load.

The structural panel may desirably be provided with one or more reinforcing struts positioned on, or adjacent, to the rear side of the flat rectangular panel interior to any C strut section. A reinforcing struct may take the form of one or more planar and generally rectangular panels proportioned to cross-link side panels and/or rear tabs. Reinforcing struts may be welded in place or fixed in any other appropriate manner. In embodiments, two reinforcing struts may intersect at their mid-points and be welded where their intersection to form a cross-bar structure on the rear-side of the flat rectangular panel.

A structural panel according to the present invention may be manufactured from a suitable metal alloy resistant to corrosion such as stainless-steel, for example a high grade stainless-steel. Galvanised mild steel may be used, for example where ancillary parts are not available in stainless steel of where the cost of using stainless steel parts is considered prohibitive. Embodiments of the invention may be manufactured from non-metallic materials such a polymers or glass-fibre for applications where metal containments are not appropriate or where they are considered excessively costly.

In the case of structural panels formed of stainless-steel, the appropriate thickness and grade of metal to be specified is arrived at by modelling the structure under load when created from a given thicknesses and grade, consideration being given to robustness and resistance to deformation while minimising the weight of each panel and the cost of the metal. A typical example may be grade 304 stainless-steel with a thickness of 2 mm, however this is only one example and many variant specifications may be envisaged depending on the application and the environment in which structural panel and any modular containment formed therefrom is to be placed. A feature of a temporary containment made principally from stainless-steel is the consequent creation of a Faraday cage blocking wireless transmission of data both into and out of the containment. In some circumstances such blocking of wirelessly transmitted data may be desirable. The specification of a high-grade stainless-steel furthermore promotes extended re-use of the system thereby amortising the initial manufacture cost over a prolonged exploitation lifetime.

Appropriate specification of the materials used produces a structural panel that doubles as a containment surface and supporting structure and to particular advantage, the number of parts required to create a containment system by these means is dramatically fewer than would be the case were the containment surface and the containment system to be provided as separate entities, thereby reducing cost of manufacture and costs of installation and of removal. To further advantage, the integration of a support structure with structural panel reduces the surface area available upon which dust and debris can collect and reduces the number of surface features that might provide attachment points, thereby facilitating decontamination.

To meet workplace health and safety regulatory requirements it is advantageous that the weight of each structural panel is 25 kg or less. By appropriately controlling the thickness and grade of material for relatively low mass in order to comply with regulations a further advantage resulting is the reduction of loading of the assembled structure and this in turn makes it possible to further reduce the thickness of metal used in structures ancillary to the structural panels, and in so doing reducing cost.

A modular containment system according to the present invention may be created by assembling a multiplicity of structural panels according to the present invention to form larger planar elements that can be arranged at right angles to one another such that they abut along their vertical edges. Variant forms of the modular containment system according to the present invention may also be created where the larger planar elements comprising a multiplicity of structural panels abut at an angle greater or less than 90°. Variant forms of the structural panels may include rectangles whose dimensions are selected such that when incorporated in an assemblage of structural panels a specific space-constraint can be met. Variant structural panel sizes and proportions may be provided in order to provide means of mounting egress and ingress features and mounting features for the attachment of equipment.

Structural panels abutted with one another along their upstanding edges may be mechanically fastened by any appropriate means, including, but not limited to, conventional bolts, nuts and washers or by rivets or by means of a clamping device. An example of a suitable clamping device takes the form of a robust ‘dog-clip’ actuated by bi-directional lead-screws or similar conventional mechanical means, or by other conventional engineering means to achieve a reversible assembly principle. In all of these cases the purpose is to create an assemblage of structural panels according to the present invention capable of resisting elevated mechanical loading and of distributing the loading across the structural panel wherein the flat rectangular panel of each structural panel absorbs both compression and tension loads and folded C strut portions (formed by the side panels and rear tabs) of each structural panel absorb tortional loads.

Assemblages of structural panels forming large planar units may be attached to one another by identical means to those employed to attach individual structural panels to one another in order to achieve a reversible assembly. In the case of bolting panels to one another, the rear tabs and/or side panels portions of each panel are provided with a plurality of through-holes distributed in a pattern devised to optimise load-distribution. To improve distribution of mechanical loading a generally rectangular plate provided with through-holes identically positioned to the through-holes provided in the side panels and/or rear tabs of the structural panels may be used as a form of washer by being positioned co-planar and mated with an interior wall of the side pane or rear tab such that the mechanical load exerted by nuts or bolt heads is generally distributed by the washer. A pair of washers of this type may be used at either side of an assembly to distribute mechanical loading into two structural panels thus mated.

The bolting of abutted structural panels or assemblages of structural panels may be automated by means of equipment adapted to insert bolts and to rotate them in repeat sequences. Captive nuts may be provided to panels to further simplify this process, two C struts formations being provided with captive nuts in order to receive bolts and the remaining two sides provided with through-holes to act as bolt-deliverers. A steel plate adequately thick to be tapped to receive bolts may be selected in the place of using nuts however the supplementary weight of the steel would be likely to be detrimental to the performance of the assembled structure and conventional nuts may be preferred. In the case of clamping, following appropriate positioning and abutment of structural panels, the clamp may be positioned by suitably adapted equipment and thereafter be closed to mechanically to unite the abutted panels, the means of closure of the clamping device depending on the mechanism selected. Once assembled, the junction zones between structural panels may be filled with a suitable elastomeric material applicable in liquid form and removable at the time of disassembly, however further options exist for filling the junction zones including suitably specified and dimensioned gaskets, the purpose of filling these zones being to provide a relatively uninterrupted containment surface that facilitates decontamination.

Automation or semi-automation of the assembly and disassembly process is achievable by standard industrial means including the identification of structural panels and struts by means of QR codes or bar-codes affixed to the assembly components such that they are readily visible and interpretable by human operatives, also by automation equipment equipped with suitable sensors and data-processing systems. Commonly used in construction, such means of identification can provide the assembly or disassembly team with specific information about the system component and where it is positioned in the larger structure together with information about the component's size, weight and its material characteristics. The environment within which the temporary containment is to be assembled can be emulated in a 3D simulation by means of a point-cloud generated by a Lidar scanner or depth camera or cameras. Accurate positioning of the constituent elements of the temporary containment within the emulated environment can be registered in the bar-coding or QR-coding of the constituent elements thereby enabling automation or semi-automation. The structural panels and reinforcing struts themselves may be seized and transported by human operatives or by suitably adapted automation equipment by means of venturi caps, or by suitably adapted grippers and the like to ensure accurate and safe manipulation. Sealant at the junctions between structural panels may similarly be applied by automated or semi-automated equipment, all facets of the automation or semi-automation process having the purpose of reducing the time to assemble and disassemble the temporary containment and the consequent cost. In the case of containment being required to be assembled in a highly irradiated environment, automation of the assembly and disassembly process enables the formerly impossible to be achieved.

Desirably, assemblages of structural panel elements of a modular containment system may be mechanically supplemented by reinforcing strut elements provided to and attached at the borders or edges of the modular containment system. The multiplicity of reinforcing strut elements thus mounted and mechanically linked at the intersection points of the assembled modular containment system form a space-frame, and in so doing provide supplementary dimensional mechanical stiffness to the modular containment system. The reinforcing strut elements may be formed from steel box sections, their cross-sectional dimensions being determined by simulation of given variants of the structure under mechanical load to obtain desirable dimensional stability while limiting mass and the cost of materials. The reinforcing strut elements may be attached to the assemblages of structural panels by identical means to those used to assemble the assemblage of panels, in so doing simplifying the assembly process and reducing cost and complexity. Depending on the environment and the nature of the tasks to be performed within the modular containment system the size and proportions of the various assemblages of structural panels need to be adapted and it is implicit that the reinforcing strut elements must be specified to match these requirements. The reinforcing strut elements can be sized and specified using standard parametric principles, obviating the need for redesign and making the design and specification process rapid and cost-effective.

The manufacture of the structural panels themselves may be automated or semi-automated by adapting folding and welding equipment to the task and by these means gaining economies of both time and cost.

A horizontal element or ceiling portion of a modular containment structure according to the present invention may be created in identical manner to the creation of vertical elements, by assembling a plurality of structural panels according to the present invention whose dimensional mechanical stability serves to resist any significant deflection. The use of the same structural panels throughout the modular containment system greatly simplifies the manufacturing, installation and removal processes and confers cost and time economies on the entire process.

Temporary modular containment structures according to the present invention, while limiting or preventing egress and ingress of dust, fragments of material, liquids, smoke and contaminated materials and providing means of controlling human access to a designated work zone, and thereby information, may be required to provide the transmission of services such as electricity, data, water, hydraulic fluid, gases and compressed air, and will be required to provide means of accessing the enclosed work space, both by equipment and by human operatives. A further requirement may be for means of seeing into or out of the enclosed zone. Therefore it may be necessary to provide means by which the structural panels can be adapted to meet these requirements. In a preferred construction of the modular containment system of the present invention the structural panels may be adapted to provide means of egress and ingress without compromising the integrity and dimensional mechanical stability of their structure. In the case of doors and windows, mechanical fittings for pipework, cabling and the like, a portion of the flat rectangular panel of the structural panel may be removed to create a mounting aperture for standard commercially available fittings or for bespoke fittings. The mechanical properties of the structural panel determine a maximum size of aperture and a minimum distance between sides of an aperture and an edge of the structural panel. The structural panels can be modified by standard industry methods including laser-cutting and water-jet cutting to suit specific requirements and in so doing rendering the system readily reconfigurable.

Further features and advantages of the present invention will be apparent from the preferred embodiment shown in the Figures and discussed below.

### DRAWINGS

FIG. 1 shows details of the construction of a modular containment system according to the present invention;

FIG. 2 shows further details of the construction of the modular containment system of FIG. 1; and

FIG. 3 shows a structural panel according to the present invention.

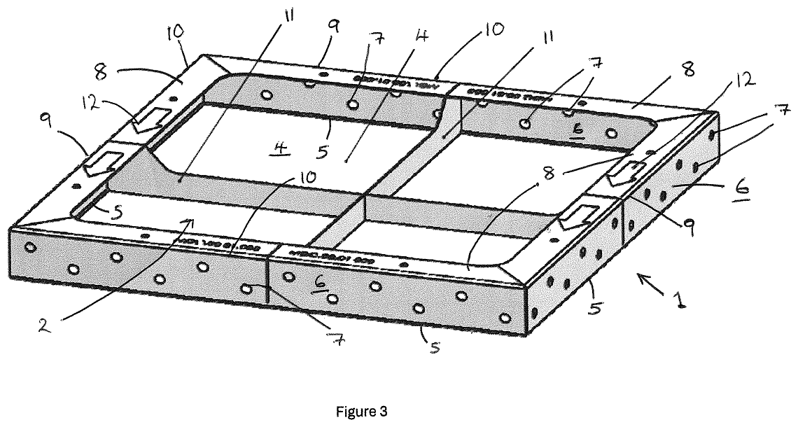

A structural panel 1 according to the present invention is shown in FIG. 3. The structural panel 1 consists of a flat rectangular panel 2 having a front side 3, a rear side 4, and four edges 5. Extending from each of the four edges 5 of the flat rectangular panel are side panels 6. The side panels 6 each have a plurality of fixing holes 7 formed therethrough. The side panels 6 are attached to an edge 5 of the flat rectangular panel 2 at an outer edge 10, are flat, and each have an inwardly extending rear tab 8 extending from an inner edge 9. The rear tabs 8 are also flat and have fixing holes 7 formed therethrough. The side panels 6 are welded to an adjoining side panel at each corner of the structural panel 1. The rear tabs 8 are cut at 45° at each end and are welded to an adjoining rear tab 8. Together the flat rectangular panel 2, the side panels 6, and the rear tabs form a c-struct structure in cross section. Two reinforcing struts 11 are provided on the rear side 4 of the flat rectangular panel 2. The reinforcing struts 11 are each adjoined to a mid point of a side panel 6 and a rear tab 8 at each end. The reinforcing struts 11 also intersect each other at their midpoint. The reinforcing struts 11 are welded in position. Markings 12 are provided on a visible side of the rear tabs 8 to indicate the correct orientation of the structural panels when in use. The structural panel 1 is formed of 2 mm thick stainless steel plate and, as a result, is strong and corrosion resistant.

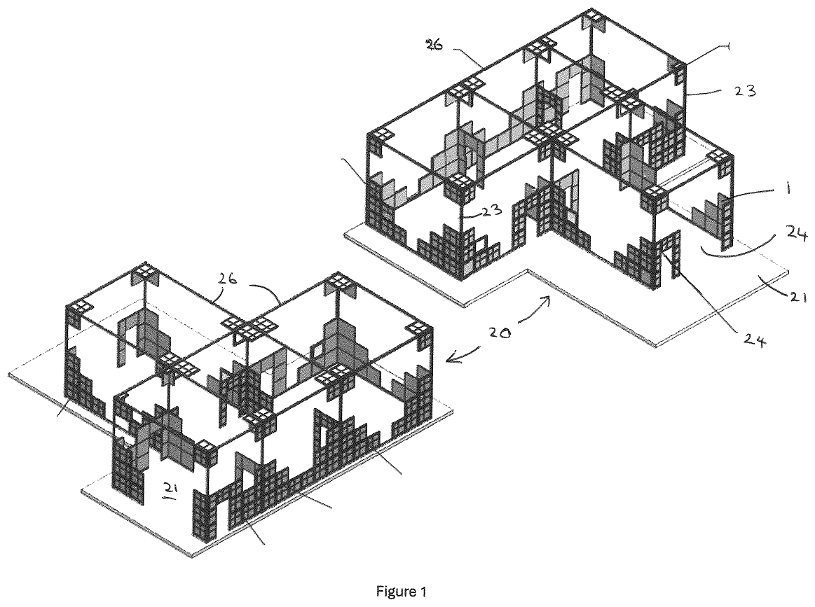

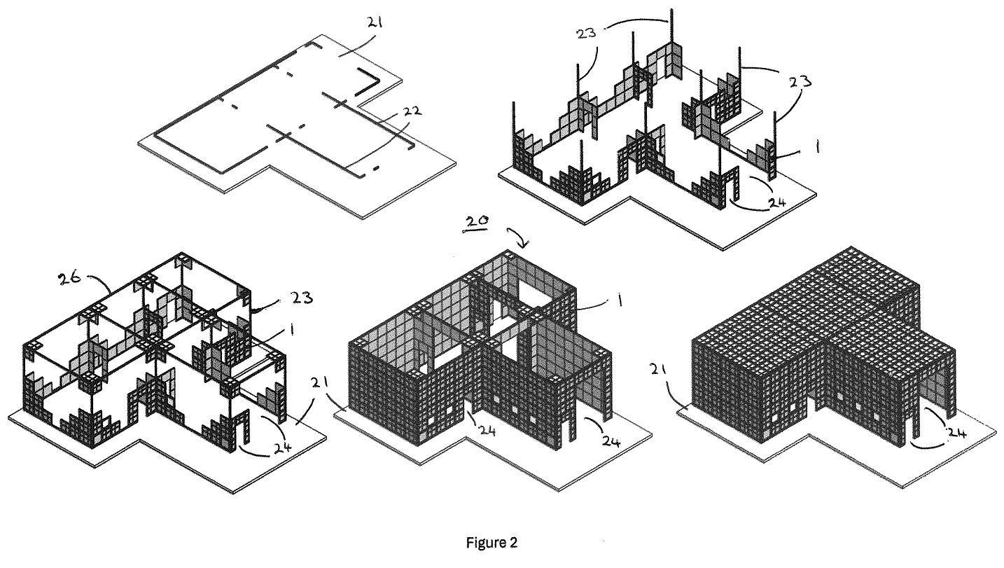

The structure of a modular containment system 20 from a plurality of the structural panels 1 of FIG. 3 is shown in FIGS. 1 and 2.

The steps of construction are best illustrated in FIG. 2. First, a base 21 formed of concrete is formed. Channels 22 are provide in the base for aligning the structural panels 1. Then corner posts 23 and structural panels 1 are positioned in the channels at appropriate positions. The structural panels 1 are bolted to one another and in position utilising nuts and bolts positioned through the fixing holes. The structural panels 1 are fixed in position to reinforce the corner posts and to form access points 24 and windows 25.

After reinforcement of the corner posts 23 roof posts 26 are fixed in position and further structural panels 1 are fixed in position to reinforce the junctions of the roof posts 26 and corner posts 23. Subsequently walls of the modular containment system 20 are filled in with further structural panels 1. Finally, a roof of the modular containment system 20 is completed using further structural panels 1.

Unless otherwise indicated by context or the claims any feature of the embodiment shown in the Figures may be included in any other embodiment of the invention independently from the other features of the embodiment shown in the Figures.

1. A structural panel for a modular containment system, the structural panel comprising:
a flat rectangular panel having a front side, a rear side, and four edges;
four side panels, each extending rearwardly from a different one of the four edges perpendicular to the rear side of the rectangular flat panel, each having a front edge affixed to the flat panel and a rear edge; and
four rear tabs, each extending inwardly from a rear edge of a different one of the four side panels, and being parallel to the rear side of the rectangular flat panel.

2. The structural panel according to claim 1, wherein one or more corners of the flat rectangular panel and associated portions of the side panels and rear tabs are cut off.

3. The structural panel according to claim 2, wherein all four corners of the flat rectangular panel and associated portions of the side panels and rear tabs are cut off such that the front side of the flat rectangular panel is substantially octagonal.

4. The structural panel according to claim 1, wherein one or more reinforcing struts are provided on the rear side of the flat rectangular panel, each reinforcing strut extending between opposing side panels.

5. The structural panel according to claim 4, having two reinforcing struts provided on the rear side of the flat rectangular panel, each reinforcing strut extending between opposing side panels and the two reinforcing structs being perpendicular to one another.

6. The structural panel according to claim 5, wherein each end of each reinforcing strut has a first end and a second and each of the first ends and the second ends is positioned at a midpoint of an edge of the flat rectangular panel.

7. The structural panel according to claim 6, wherein two or more of the side panels abut each other at a corner of the flat rectangular panel.

8. The structural panel according to claim 7, wherein the side panels are welded together where they abut.

9. The structural panel according to claim 7, wherein two or more lateral ends of the rear tabs are cut at an angle of 45° such that they abut an adjacent lateral end of a rear tab that is also cut at an angle of 45°.

10. The structural panel according to claim 9, wherein the adjacent lateral ends of the rear tabs that abut one another are welded together.

11. The structural panel according to claim 1, formed of stainless steel and/or galvanised mild steel.

12. The structural panel according to claim 1, formed of a polymer, carbon-reinforced polymer, or fibre-glass.

13. The structural panel according to claim 11, formed of grade 304 stainless steel.

14. The structural panel according to claim 13, wherein the stainless steel has a thickness of between 1.5 mm and 2.5 mm.

15. The structural panel according to claim 1, wherein the weight of the panel is 25 kg or less.

16. A modular containment system comprising a plurality of structural panels according to claim 1, wherein the plurality of structural panels are affixed together to form a complete container.

17. The modular containment system according to claim 16, wherein the container is substantially cuboid and adjacent structural panels are affixed to each other at right angles to form the corners and edges of the container.

18. The modular containment system according to claim 16, wherein adjacent structural panels are mechanically fastened to one another by one or more of conventional bolts, nuts and washers, rivets, or clamping devices.

19. The modular containment system according to claim 18, wherein the clamping devices consist of a dog clip actuated by bi-directional lead-screws.

20. The modular containment system according to claim 19, wherein each of the plurality of the structural panels have through holes provided through the side panels and/or rear tabs to allow them to be bolted to one another.

21. The modular containment system according to claim 20, wherein bolts and washers are positioned through the through holes to bolt the structural panels together.

22. The modular containment system according to claim 16, wherein junctions between adjacent structural panels are filled with an elastomeric material and/or a gasket.

23. The modular containment system according to claim 16, further comprising strut elements for reinforcing the containment system.

24. The modular containment system according to claim 23, wherein the strut elements are formed of steel box sections.

25. The modular containment system according to claim 16, comprising a ceiling portion formed of a plurality of structural panels, each the structural panel comprising:
a flat rectangular panel having a front side, a rear side, and four edges;
four side panels, each extending rearwardly from a different one of the four edges perpendicular to the rear side of the rectangular flat panel, each having a front edge affixed to the flat panel and a rear edge; and
four rear tabs, each extending inwardly from a rear edge of a different one of the four side panels, and being parallel to the rear side of the rectangular flat panel.

26. The structural panel according to claim 1, further comprising one or more mounting apertures for conforming to fittings.
